(19) United States
(12) Patent Application Publication
(10) Pub. No.: US 2026/0348419 A1
(43) Pub. Date: Nov. 5, 2026

(54) Magnetic System for Fitting Nuts and Bolts While Changing the Tires of Different Models of Cars

(71) Applicant: Roberto Soto Santana, Mayaguez, PR (US)

(72) Inventor: Roberto Soto Santana, Mayaguez, PR (US)

(21) Appl. No.: 19/405,495

(22) Filed: Dec. 2, 2025

Related U.S. Application Data
(60) Provisional application No. 63/797,611, filed on Apr. 30, 2025.

(51) Int. Cl. F16B 39/10; B60B 3/16

(52) U.S. Cl. CPC F16B 39/10; B60B 3/16; F16B 2200/83

(57) ABSTRACT

A washer system designed to protect nuts and bolts from shearing due to excessive torque during automobile tire changes. The system's main component is a single permanent magnet, which ensures optimal allowable stress—neither too high nor too low—during wheel or tire changes. The packing ring is placed before the nut used to tighten the car rims, preventing the nuts and bolts from reaching their limits and avoiding breakage or damage during tightening.

### RELATED APPLICATIONS

This application is a non-provisional application of, and claims priority under 35 U.S.C. § 119(e) to, U.S. Provisional Application No. 63/797,611, filed Apr. 30, 2025, and entitled “Magnetic System for Fitting Nuts and Bolts While Changing the Tires of Different Models of Cars”, the entire contents of which are incorporated by reference.

### BACKGROUND OF THE INVENTION

A correct and controlled tightening of the bolts and nuts on the wheel is essential for safe driving, as it ensures the wheels are securely fastened. Over-tightening these components can lead to serious issues. Excessive pressure applied during tightening can cause the threads of the bolts or nuts to break or become damaged. If the wheel bolts are too tight, it can also cause the threads to scratch or the bolts to stretch. This can lead to the deformation of critical components such as brake drums, rotors, or wheel hubs.

### BRIEF SUMMARY OF THE INVENTION

The invention is a washer system designed to protect nuts and bolts from shearing due to excessive torque during automobile tire changes. The system's main component is a single permanent magnet, which ensures optimal allowable stress—neither too high nor too low—during wheel or tire changes. The packing ring is placed before the nut used to tighten the car rims, preventing the nuts and bolts from reaching their limits and avoiding breakage or damage during tightening.

### BRIEF DESCRIPTION OF THE DRAWINGS

FIG. 1—Positioning system for bolt and nut

FIG. 2—Front view

FIG. 3—Top view

FIG. 4—Bottom view

FIG. 5—Side view

FIG. 6—Perspective (3D) View

### DETAILED DESCRIPTION OF THE INVENTION

While various solutions have been developed to control the torque applied to bolts or to prevent their accidental loosening—as shown in patents JP2010214564A, U.S. Pat. No. 5,154,242A, and U.S. Pat. No. 11,433,518B2, which focus on ensuring appropriate torque application without complex manual intervention, and patents U.S. Pat. No. 11,499,586B2, U.S. Pat. No. 3,329,190A, and U.S. Pat. No. 1,058,386A, which describe components capable of presetting torque or locking mechanisms to prevent unintended displacement—the present invention stands out by incorporating a specialized washer specifically designed to absorb excess torsion. This washer not only acts as a physical torque limiter but also directly prevents bolt breakage caused by over-tightening.

Additionally, the following patents were identified: US 2025/0109810 A1, US 2025/0109765 A1, US 2024/03337281 A1. Although the U.S. patent 2025/0109810 A1 appears to be a type of washer, it is not used for the same purpose as the present invention; it seeks to create a seal to prevent a type of leak. The U.S. patent 2025/0109765 A1 appears to be a washer but is not used for the same purpose as the invention. While the U.S. patent 2024/03337281 A1, although it has a similarity in terms of the purpose of the invention, it is not the same in terms of physical characteristics. This invention includes several types of washers and equipment (gun) for adjusting the nuts. However, the washers illustrated in this invention are not adjustable and magnetic. Since the invention is an adjustable and magnetic washer, it provides greater versatility in use, making it even more useful.

The system consists of a small magnetic washer placed on each bolt or screw used to secure the tire. The main function of this system is to act as a shock absorber, preventing bolts or screws from breaking or snapping during tire adjustments. This reduces the risk of damage, ensuring that the bolts remain intact, and the tire stays securely attached.

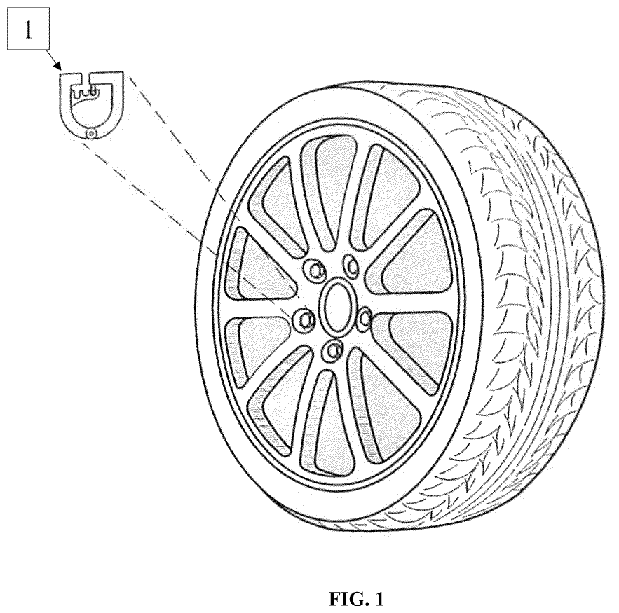

In FIG. 1, the position of the system is shown (1), placed on a single bolt as an example. This sketch includes the end of the bolt, tightening nut for assembly, and the position of bolt and nut, as shown together at the upper left corner.

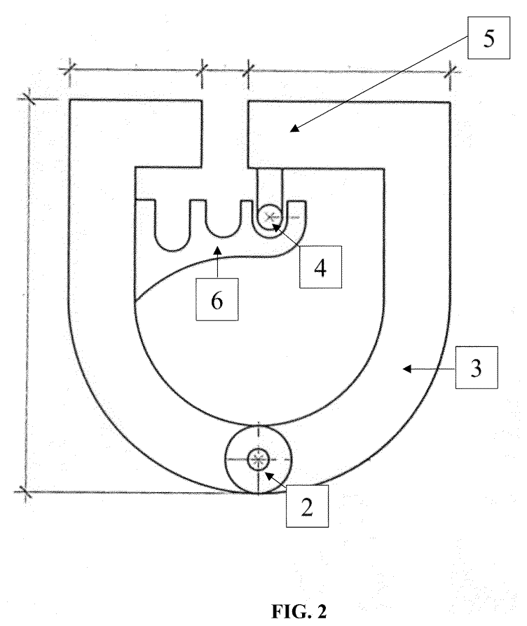

In FIG. 2, the front view of the assembly is sketched. It includes the following parts: Rotative ring with pin (2) which allows the mobility of the magnet base on the left side and the magnet base on the right side, enabling the invention to open and close; the base of the magnet (3) which allows the invention to be fixed and held with the bolt and ring of the vehicle; the rounded flat end (4) which allows the adjustment of the invention according to the size of the vehicle's bolts by placing this piece in one of the three holes of the “base for positioning the hole.”; arm of the tube (5) which holds the rounded flat end, and the base for the position of the hole orifice (6) a piece with three holes, which are used to place the “rounded flat end” and thus be able to close the invention according to the size of the vehicle's bolt.

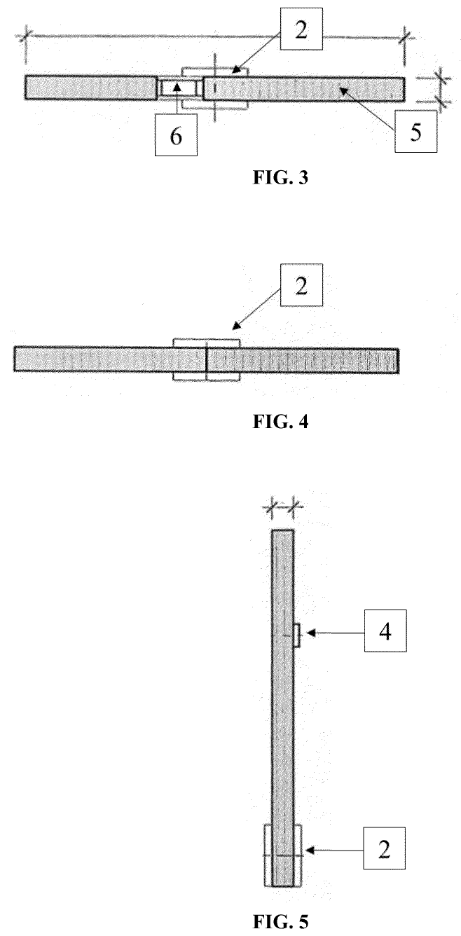

In FIG. 3, the top view of the assembly is sketched. It includes the following parts: rotative ring with pin (2), arm of the tube (5) and the base for the position of the hole orifice (6).

In FIG. 4, the bottom view of the assembly is sketched. It includes the rotative ring with pin (2).

In FIG. 5, the side view of the assembly is sketched. It includes the following parts: the rotative ring with pin (2) and the rounded flat end (4).

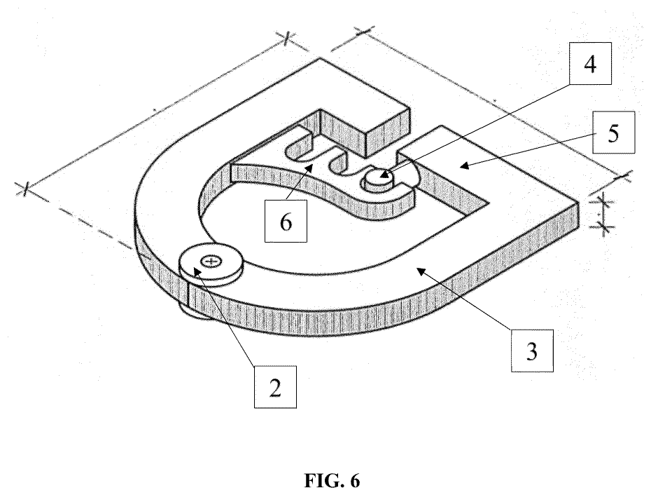

In FIG. 6, the isometric View in 3D perspective is given. This view is essentially the side view in 3D of the assembly for the bolt and the nut of the tire of a car. This isometric view includes the rounded flat end (4), base of the magnet (3), rotative ring with pin (2), and the base for the position of the hole orifice (6).

Since each model of car has different dimensions for the fire assembly, these three sketches don't give the dimensions in inches. These dimensions should be suggested by each auto maker, once the idea of this Conceptual patent is approved.

1. An adjustable and magnetic washer system design for absorbing the excess torsion preventing bolt breakage by over-tightening, the system comprising:
a U-shaped body comprising a left magnet base segment and a right magnet base segment, wherein the left and right magnet base segments form a horizontal top with a gap between them;
a rotating ring with a hinge that joins the left magnet base segment and the right magnet base segment, allowing the left magnet base segment and a right magnet base segment to move closer together or apart.
a locking base plate connected to one of the left or right magnet base segments, the locking base plate comprising at least two holes;
an arm extending inward into the U-shape from the left magnet base segment or the right magnet base segment;
and the arm comprising a rounded flat end, wherein the rounded flat end is configured to be inserted into any of the holes on the locking base plate to adjust how tightly the U-shaped body fits around a bolt according to its size.

2. The system of claim 1, wherein the hinge comprises a rotatable ring with a pin.

3. The system of claim 1, wherein the left magnet base segment and the right magnet base segment are configured to hold the system securely in place on a vehicle's wheel bolt.

4. The system of claim 1, where the system is built to act like a shock absorber when the bolt is tightened too much.

5. The system of claim 1, wherein the system is configured for use on a wheel bolt for a vehicle tire.

6. The system of claim 1, wherein the locking base plate comprises three holes on one magnetic piece.

7. A method for absorbing excess torsion in a washer system and preventing bolt breakage by over-tightening, the method comprising:
fitting the U-shaped body of the washer system around a bolt, wherein the U-shaped body has a left magnet base segment and a right magnet base segment joined by a rotating ring with a pin, allowing the U-shaped body to open and close; wherein the left and right magnet base segments form a horizontal top with a gap between them;
joining the left magnet base segment and the right magnet base segment with a rotating ring with a hinge, allowing the left magnet base segment and a right magnet base segment to move closer together or apart.
Connecting a locking base plate to one of the left or right magnet base segments, the locking base plate comprising at least two holes;
Possessing an arm extending inward into the U-shape from the left magnet base segment or the right magnet base segment;
Comprising the arm a rounded flat end, wherein the rounded flat end is configured to be inserted into any of the holes on the locking base plate to adjust how tightly the U-shaped body fits around a bolt according to its size.
Closing the U-shaped body and inserting a rounded flat end into a hole on a locking base plate to adjust how tightly the system fits around the bolt;
Securing the system in place via the left magnet base segment and the right magnet base segment;
Assembling the washer onto a bolt and securing it with a nut, wherein the washer is positioned between the bolt base and the nut.

8. The method of claim 7, wherein the hinge comprises a rotatable ring with a pin.

9. The method of claim 7, wherein an arm holds the rounded flat end.

10. The method of claim 9, wherein the arm is straight.

11. The method of claim 7, wherein the left magnet base segment and the right magnet base segment are configured to hold the system securely in place on a vehicle's wheel bolt.

12. The method of claim 7, wherein the system is built to act like a shock absorber when the nut is tightened too much.

13. The method of claim 7, wherein the bolt is a wheel bolt for a vehicle tire.

14. The method of claim 7, wherein the locking base plate comprises a base with three holes on one magnetic piece.
